(19) United States
(12) Patent Application Publication
(10) Pub. No.: US 2003/0232229 A1
(43) Pub. Date: Dec. 18, 2003

(54) Cooling arrangement

(76) Inventor: Rene Stig Bergqvist, Fredriksberg (DK)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/171,999

(22) Filed: Jun. 17, 2002

(51) Int. Cl. H01M 8/04

(52) U.S. Cl. 429/26; 429/13

(57) ABSTRACT

The present invention relates to an arrangement for improving the operating conditions when a unit is powered by a fuel cell. Examples of such powered units could be units housed in a portable equipment such as a laptop, a PDA, a mobile station or the like. The invention can also be used in a base station in a radio access network, which base station is power supplied by a backup power source.

According to the invention, a unit, powered by a fuel cell, is positioned adjacent to a corresponding fuel storage unit. In this way, heat is transferred from the powered unit due to the endothermic process occurring in the storage unit when emitting fuel, in gas phase, to the fuel cell. The symbiotic relationship between the powered unit, the fuel cell and the fuel storage unit provides improved operating conditions.

### TECHNICAL FIELD

The present invention relates to an arrangement for improving the operating conditions when a unit is powered by a fuel cell. Examples of such powered units could be units housed in a portable equipment such as a laptop, a PDA, a mobile station or the like. The invention can also be used in a base station in a radio access network, which base station is power supplied by a backup power source.

### BACKGROUND OF THE INVENTION

A fuel cell generates electrical power by continuous conversion of chemical energy of a fuel into electrical energy by way of an electrochemical reaction, without combustion. Fuel cells typically utilize hydrogen, stored in a fuel storage container, as the fuel, and oxygen (usually from air) as the oxidant in the electrochemical reaction. The reaction results in electricity, by-product water, and by-product heat.

The process of emitting fuel, in gas phase, from a fuel storage container is an endothermic reaction, and so the fuel storage container, when supplying fuel, is lowered in temperature. The fuel-emitting ability of the fuel storage container lowers as the temperature lowers, and therefore in order to secure a sufficient flow of hydrogen, it has been proposed to utilize heat, generated from the fuel cell, for heating the hydrogen storage container.

For example, U.S. Pat. No. 6,057,051 discloses a fuel cell assembly which is to power portable electronic equipment. The fuel cell assembly comprises a fuel cell body and a hydride hydrogen storage unit. Waste heat generated by the fuel cell body is conducted by an air flow produced by an air feed device to the hydrogen storage unit. Thus, the waste heat of the fuel cell is transferred to the storage unit in order to heat the hydrogen storage unit and improve its fuel-emitting ability.

Electrical and electronic components (e.g. microprocessors, power amplifiers, power semiconductors etc.) generate heat which affects the operation and life time of the components. Also, the more the components have to work, the hotter they get which in many cases makes them perform worse and need more power. Today, various devices and methods are provided for cooling power consuming electronic components. CPU fans, cooling fins, heat sinks and water cooling are examples of such cooling devices.

### SUMMARY OF THE INVENTION

An object of the present invention is to provide improved operating conditions when a unit is powered by a fuel cell.

According to the present invention, this object is achieved, according to a first aspect, by an arrangement according to claim 1, and according to a second aspect, by a method according to claim 8.

By positioning a unit, powered by a fuel cell, adjacent to a corresponding fuel storage unit, heat is transferred from the powered unit to the storage unit, i.e. absorbed by the storage unit, due to the endothermic process occurring in the storage unit when emitting fuel, in gas phase, to the fuel cell. There is a symbiotic relationship between the powered unit, the fuel cell and the fuel storage unit. Suppose the power consumption of the powered unit is increased. Then the fuel cell has to provide more power which increases the fuel cell's need for fuel. Thus, the fuel storage unit has to provide more fuel which increases the fuel storage unit's need for heat. The positioning of the powered unit adjacent to the fuel storage unit transfers heat from the powered unit to the storage unit and, thus, the power consumption of the powered unit is, in most cases, decreased.

Another advantage is that the heat from the powered unit helps keeping the temperature of the fuel storage unit up, thus permitting it to operate at an advantageous work temperature even when releasing a lot of fuel. Thus, by positioning the powered unit next to the fuel storage unit temperature fluctuations, of the storage unit and the whole arrangement, are decreased.

According to other aspects of the present invention there is provided an arrangement according to claim 12 and a method according to claim 13 for cooling a unit powered by a fuel cell.

In accordance with the symbiotic relationship explained above, the positioning of a powered unit adjacent to the fuel storage unit will cool the powered unit due to the endothermic process occurring in the storage unit. In other words, the more the powered unit has to work, the hotter it gets which makes it perform worse and then needs more power, which in turn makes the fuel cell work even harder and thus drawing more fuel from the storage unit. The released amount of fuel is proportional to the power consumption of the powered unit. As more fuel is drawn from the storage unit, the storage unit gets colder. The positioning of the powered unit adjacent to the fuel storage unit will thus cool the powered unit. This cooling of the powered unit will prevent the powered unit from getting hotter and hotter and possibly overheating. Moreover, the cooling will in some cases advantageously affect the power consumption of the powered unit since this consumption in most cases will decrease.

According to another aspect of the present invention there is provided a portable unit according to claim 14 for improving the operating conditions when a unit, included by the portable unit, is powered by a fuel cell.

Portable electronic equipment is solely dependent on its own housed power source when the equipment is not connected to a main power source. Portable equipment is usually quite power consuming, especially when subject to s some special activities. The power capacity of a laptop, or a note book, usually only lasts for a few hours.

By providing a portable unit with an arrangement that absorbs heat from a powered unit, due to the positioning of the powered unit adjacent to a fuel storage unit, improved operating conditions for the portable unit are achieved. These includes cooling of the powered unit, which in turn have an advantageous effect on the power consumption of the powered unit and, thus, the overall portable unit. This advantageous effect on the power consumption will increase the active time of the portable unit,

According to other aspects of the present invention there is provided a mobile station, a user equipment, and a PDA according to claims 17, 18 and 19 for improving the operating conditions when a unit, included by the mobile station, the user equipment, and the PDA is powered by a fuel cell.

A mobile station, or a user equipment, in active-mode, i.e. engaged in transmitting and receiving information, is very power consuming. The power capacity of a PDA is also limited, especially when it is subject to some power consuming activities.

In a mobile station, a user equipment and a PDA, it is possible to increase the active time by exploiting the effects of the emitting process of the fuel release from the fuel storage unit to absorb heat from the power consuming electronic components of these devices, especially when the devices are subject to power consuming activities.

As is understood, the present invention is applicable in any kind of wireless communication terminal, such as in terminals connected to GSM, UMTS, PDC, AMPS, D-AMPS, CDMAone or CDMA2000 networks.

According to another aspect of the present invention there is provided a base station according to claim 20 for improving the operating conditions when a unit, included by the base station, is powered by a fuel cell.

By providing an arrangement which absorbs heat from a powered unit within the base station, the power consumption of the base station is decreased and, thus, the power capacity is increased. The transmitters power amplifier in base stations is quite power consuming. The storage unit can be made relatively big, thus increasing the heat absorption effect. Since it is not so critical to work at low pressures, it is here possible to use other metalhydrids, or even gaseous hydrogen as fuel (gaseous hydrogen needs pressure around 300 bars to be used as a fuel). The fuel cell makes an excellent backup power source for a base station. Indeed, the advantageous effects of the arrangement itself and of its provision in a portable unit will also be present when including the arrangement in a base station.

In preferred embodiments of the present invention the powered unit is a power consuming electronic component and the power consumption of said component is decreased by way of the heat absorption process. Thus, the present invention improves the operating conditions and increases the life time of the components.

In yet other embodiments of the present invention a heat-conducting element is positioned between the fuel storage unit and the powered unit. Examples of such heat-conducting elements are thermal joints made of copper, aluminium or any other kind of heat conducting material.

Using these elements between the fuel storage unit and the powered unit provides a more uniform heat distribution in the powered unit as heat is transferred from the powered unit to the storage unit. Indirectly, the elements increases the area of contact between the fuel storage unit and the powered unit.

In yet other embodiments of the present invention the fuel cell unit and the fuel storage unit can constitute one unit which is electrically and mechanically removably connected to the fuel cell powered arrangement. Manufactures of these units can thus make a variety of different fuel cell devices which are compatible with different kind of equipments, such as portable units and base stations. Thus it is possible to use the fuel cell device in the same way as traditional batteries are used. Like batteries, it is also possible for a user of e.g. a fuel cell powered mobile station, to change fuel cell device or the fuel storage unit in the mobile station when power capacity is getting low.

In yet other embodiments of the present invention the powered unit is a CPU or a power amplifier. These powered units are quite power consuming and can thus take advantage of the present invention.

### BRIEF DESCRIPTION OF THE DRAWINGS

Further features and advantages of the invention will become more readily understood from the following detailed description of exemplifying embodiments of the invention when taken in conjunction with the accompanying drawings, in which:

FIG. 1 is a schematic diagram showing an arrangement according to the invention which provides heat absorption.

FIG. 2 shows a portable unit which is arranged to include the inventive fuel cell arrangement.

### DETAILED DESCRIPTION OF THE INVENTION

An electrochemical fuel cell is a device that reacts a fuel source with an oxidizing agent to produce an electric current. Commonly, the fuel source is a source of protons, such as hydrogen gas, and the oxidizing agent is oxygen. An example of a fuel cell utilizing these reactants is a proton exchange membrane (PEM) fuel cell, in which hydrogen gas is catalytically dissociated in the fuel cell's anode chamber into a pair of protons and electrons. The liberated protons are drawn through an ion conductive membrane into the fuel cell's cathode chamber. The electrons cannot pass through the membrane and instead must travel through an external circuit to reach the cathode chamber. In the cathode chamber, the protons and electrons react with oxygen to form water and heat, The net flow of electrons from the anode to the cathode chambers produces an electric current, which can be used to meet the electrical load being applied to the fuel cell by an associated electrical device.

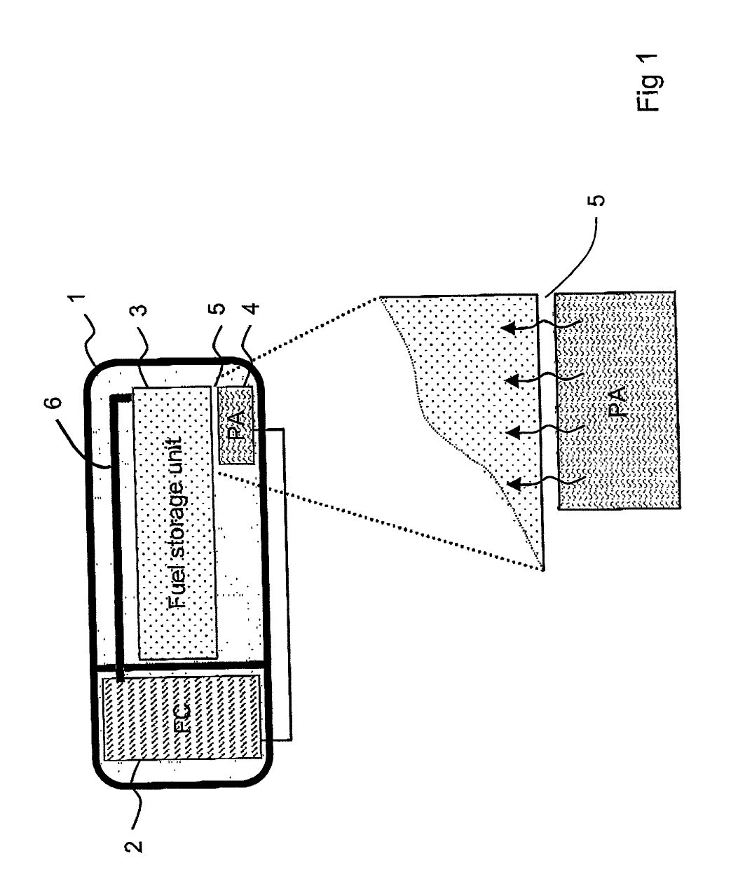

FIG. 1 is a schematic diagram showing an arrangement 1 according to an embodiment of the invention. A fuel cell unit (FC) 2 acts as a power source for a powered unit 4. The powered unit could be a power consuming electronic component, and is here exemplified by a power amplifier (PA) 4. Even though the fuel cell unit 2 here is depicted as the only power source for the PA 4, there can be other power sources, such as a main power or conventional batteries. The electronic component can be any heat sensitive electrical component that produces a lot of heat when active, but which operates best when it is not too hot. A power amplifier or a CPU included in a mobile terminal, a PDA, a laptop, a notebook, an MP3-player or a portable game console are examples of such power consuming electronic components.

The PA 4 is positioned adjacent to a fuel storage unit 3. A thermal joint 5 is used as a heat-conducting element between the PA 4 and the fuel storage unit 3, in order to provide a uniform heat distribution in the PA 4 as heat is transferred from the PA 4 to the storage unit 3. One of the enlarged sections of FIG. 1 shows heat being transferred from the PA 4 to the fuel storage unit 3.

If the working load of the PA 4 is increased the PA 4 gets hotter which makes it perform worse and, thus, need more power. By way of an electrochemical reaction in the fuel cell 2 between a fuel, hydrogen in this case, and air (oxygen) chemical energy is converted to electricity. In the storage unit 3, metal hydride is converted to hydrogen for the purpose of serving as fuel for the fuel cell 4. The electrochemical reaction, i.e. releasing hydrogen gas from the metal hydride, also results in water as a by-product. The required amount of fuel is proportional to the power consumption of the PA 4. Hydrogen is supplied to the fuel cell 4 through a supply line 6 connecting the storage unit 3 and the fuel cell 4, As chemical energy is converted to electricity, the fuel storage unit 3 has to provide more fuel which increases the fuel storage unit's 3 need for heat. Heat is required for converting the fuel into hydrogen gas, H₂. The positioning of the PA 4 adjacent to the fuel storage unit 3 will transfer heat from the PA 4. Furthermore, the supply line can be positioned in relation to the powered unit in such way that it contributes to the heat transfer from the powered unit, The heat transfer from the powered unit to the storage unit also implies that the powered will preheat the storage unit. Thus, the PA 4 is prevented from getting hotter and hotter and the power consumption of the PA 4 is decreased.

The supply line 6 is preferably made of some metal, like a steel or aluminium pipe. It is also possible to use the supply line 6 as a heat absorbing device by positioning part of the supply line 6 adjacent to the powered unit 4.

Many different kinds of metal hydrides can be used, although hydrogen ones are preferred at the moment. Some examples of common metal hydrides are MgH₂, MgNiH₄, TiFeH_{1.96} and LaNi5H₇. LaNi5H₇ is an AB5 alloy, commonly known to a person skilled in art. This is also the type of metal hydride best suited for the invention as it can easily be tailored to work at specific temperatures and pressures by varying the A and B components of the AB5 alloy. AP2 alloys can also be used. The use of carbon nanotubes is also envisaged. As yet another alternative, methanol based fuel cells could also be used as they are easier to build in smaller formats.

As the pressure, when working with AB5s, is quite low, approximately 1-15 bars, the fuel storage unit 3 could be given any other form than cylindrical or round, which are the common forms of pressurized containers, in order to maximize the area of contact between the fuel storage unit and the power consuming electronic component. Increasing the area of contact, i.e. using flat surfaces, provides a more efficient heat exchange and the heat transferring effect is thus improved. The storage unit can be made of any heat conducting material. However, it is preferred to keep the weight of the storage unit low.

The fuel cell unit 2, which works best at higher temperatures (approx. 45-80° Celsius depending on the design), is preferably isolated from the storage unit 3 by a heat isolating member in order to prevent cooling of the water steam, which then would turn into water risking to flood the fuel cell unit 2 Alternatively, the fuel cell unit 2 and fuel storage unit 3 are simply kept separated from each other.

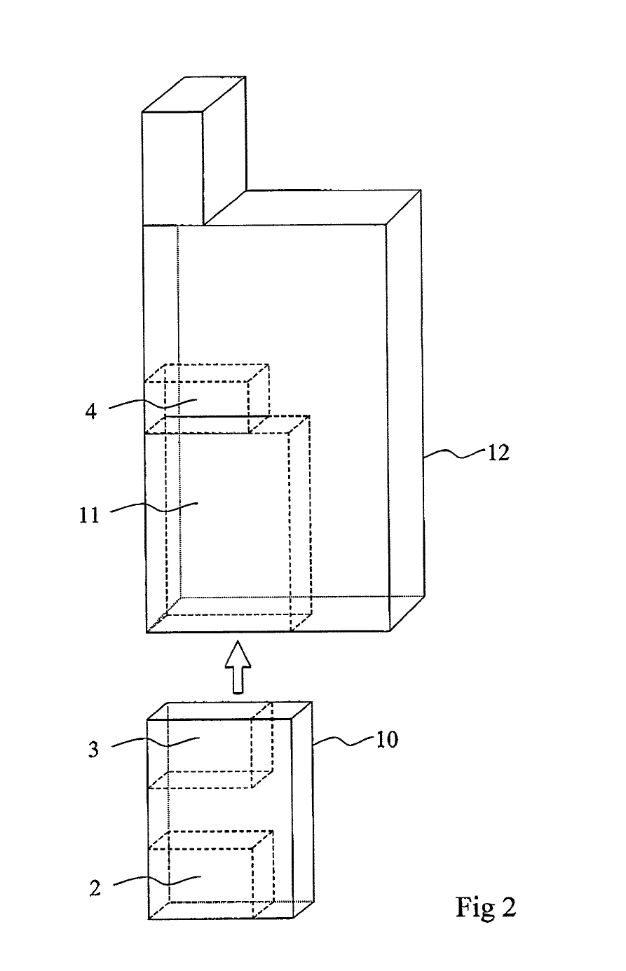

FIG. 2 is a perspective view showing a portable unit 12, which includes a powered unit 4 and a fuel device-receiving portion 11. A portable fuel device 10, which includes the fuel cell unit 2 and the fuel storage unit 3 previously described with reference to FIG. 1, is electrically and mechanically removably connected to the portable unit 12. When the portable fuel device 10 is fully inserted into the fuel device-receiving portion 11 of the portable unit 12, the powered unit 4 will be positioned adjacent to the fuel storage unit 3, thus making it possible to benefit from the endothermic reaction of the fuel storage unit 3 and absorb heat from the powered unit 4. The other components, necessary for the mechanical and electrical connection of the portable fuel device 10, and the vital fuel cell process, are not shown in FIG. 1, but are also housed within the portable fuel device 10. The portable unit 12 could be any kind of portable unit, such as a PDA, a laptop, a notepad, a portable game console or an MP3-player. Advantageously, the portable unit 12 is a wireless communication terminal in a radio access network, such as a PDA, a mobile station in a GSM network, or a user equipment in a UMTS network. By removing the “antenna part” of FIG. 2 and changing the dimensions, FIG. 2 could represent any of the above mentioned devices. The portable fuel device 10 could be used as a battery, either replacing conventional batteries or as an addition to the same.

A test prototype of the present invention applied to a mobile station of the kind used in a GSM-system illustrates the advantageous cooling effects. The numbers given below changes with variations in the transmission power level.

At full load the current drawn at the battery terminals (3.6 V) by a power amplifier (PA) of a mobile station is 2.3A/8=300 mA (single timeslot GSM—one out of 8 timeslots). 300 mA at 3.6 V requires 1.1 W power consumption. Display light and some other functions required during talk draws an additional −100 mA. A total of 400 mA at 3.6 V corresponds to 1.5 w electrical consumption. Half of the 1.1 W (300 mA * 3.6 V/2=0.55 W) lead to the PA is emitted as heat. At full load the fuel cell single cell voltage will be 0.6 V. Relating this to a theoretical maximum of 1.23 V results in an efficiency of approximately 50% based on electrical available energy (Gibbs free energy) for hydrogen. Due to the 50% efficiency, twice as much hydrogen as the theoretical amount is required to produce the needed electricity under the given circumstances. If the mobile station consumes 1.5 W then 3 W worth of hydrogen should be released from the metalhydride and be supplied to the fuel cell. 3 W is equal to 3 J/s. Gibbs free energy for hydrogen is 238000 J/mol which means that 3/238000=1.26*10⁻⁵ mol/s is released from the metalhydride. Heat of desorption of H₂ from the metalhydride is on average 30000 J/mol. This results in a cooling effect of 1.26*10⁻⁵ mol/s * 30000 J/mol=0.38 J/s=0.38 W from the metalhydride. In other words, a mobile station which consumes 1.5 W and emitts 0.55 W as heat loss, gains 0.38 W due to the cooling effect of the fuel cell arrangement. The cooling effect is thus in the same range as the heat loss.

While the preferred embodiment of the invention has been illustrated and described, it will be clear that the scope of the invention is not limited by that embodiment. Numerous modifications, changes, variations, substitutions and equivalents can be made by a person skilled in the art without departing from the spirit and scope of the present invention as defined by the appended claims.

1. An arrangement for improving the operating conditions when a unit is powered by a fuel cell, which arrangement includes:
a fuel cell unit;
a fuel storage unit connected to the fuel cell unit for supplying fuel to the fuel cell unit; and
a unit powered by the fuel cell unit;
wherein the powered unit is positioned adjacent to the fuel storage unit in order to transfer heat from the powered unit by exploiting an endothermic process occurring when emitting fuel from said fuel storage unit to said fuel cell unit.

2. The arrangement according to claim 1, wherein said powered unit is a power consuming electronic component and wherein the power consumption of said component is decreased by way of the heat transferring process.

3. The arrangement according to claim l, wherein a heat-conducting element is positioned between the fuel storage unit and the powered unit.

4. The arrangement according to claim 1, wherein said fuel cell unit and said fuel storage unit constitutes one unit which is electrically and mechanically removably connected to said arrangement.

5. The arrangement according to claim 1, wherein said powered unit is a CPU or a power amplifier.

6. The arrangement according to claim 1, wherein the fuel storage unit is separated from the fuel cell unit by a heat isolating member.

7. The arrangement according to claim 1, wherein the fuel storage unit is made in such physical form so as to maximize the area of contact that provides heat exchange between said fuel storage unit and said powered unit.

8. A method of improving the operating conditions for an arrangement which includes a fuel cell unit, a fuel storage unit and a unit powered by the fuel cell unit, wherein the powered unit is positioned adjacent to the fuel storage unit, the method including absorbing heat from the powered unit by exploiting an endothermic process occurring when emitting fuel from said fuel storage unit to said fuel cell unit.

9. The method according to claim 8, including reducing the fuel supply from the fuel storage unit to the fuel cell unit due to the decreased power consumption resulting from the heat absorption from the powered unit.

10. The method according to claim 8, wherein said powered unit is a power consuming electronic component and wherein the power consumption of said component is decreased by way of the heat absorption process.

11. The method according to claim 8, wherein a heat-conducting element is positioned between the fuel storage unit and the powered unit.

12. An arrangement for cooling a unit powered by a fuel cell including:
a fuel storage unit connected to a fuel cell unit for supplying fuel to the fuel cell unit;
wherein the powered unit is positioned adjacent to the fuel storage unit in order to cool the powered unit by exploiting an endothermic process occurring when emitting fuel from said fuel storage unit to said fuel cell unit, thereby decreasing the power consumption of the powered unit.

13. A method of cooling a unit powered by a fuel cell unit, wherein the powered unit is positioned adjacent to a fuel storage unit associated with the fuel cell unit, the method including cooling the powered unit by exploiting an endothermic process occurring when emitting fuel from said fuel storage unit to said fuel cell unit, thereby decreasing the power consumption of the powered unit.

14. A portable unit including an arrangement for improving the operating conditions when a unit included by the portable unit is powered by a fuel cell, which arrangement includes:
a fuel cell unit;
a fuel storage unit connected to the fuel cell unit for supplying fuel to the fuel cell unit; and
a unit powered by the fuel cell unit;
wherein the powered unit is positioned adjacent to the fuel storage unit in order to transfer heat from the powered unit by exploiting an endothermic process occurring when emitting fuel from said fuel storage unit to said fuel cell unit.

15. The portable unit according to claim 14, wherein the portable unit is one of the group laptop, notebook, portable game console and MP3-player.

16. The portable unit according to claim 14, wherein the portable unit is a wireless communication unit used in a radio access network.

17. A mobile station of the kind used in a Global System for Mobile communication (GSM) network, which mobile station includes an arrangement for improving the operating conditions when a unit included by the mobile station is powered by a fuel cell, which arrangement includes:
a fuel cell unit;
a fuel storage unit connected to the fuel cell unit for supplying fuel to the fuel cell unit; and
a unit powered by the fuel cell unit;
wherein the powered unit is positioned adjacent to the fuel storage unit in order to transfer heat from the powered unit by exploiting an endothermic process occurring when emitting fuel from said fuel storage unit to said fuel cell unit.

18. A user equipment of the kind used in a Universal Mobile Telecommunication System (UMTS) network, which user equipment includes an arrangement for improving the operating conditions when a unit included by the user equipment is powered by a fuel cell, which arrangement includes:
a fuel cell unit;
a fuel storage unit connected to the fuel cell unit for supplying fuel to the fuel cell unit; and
a unit powered by the fuel cell unit;
wherein the powered unit is positioned adjacent to the fuel storage unit in order to transfer heat from the powered unit by exploiting an endothermic process occurring when emitting fuel from said fuel storage unit to said fuel cell unit.

19. A personal digital assistant (PDA) including an arrangement for improving the operating conditions when a unit included by the personal digital assistant is powered by a fuel cell, which arrangement includes:
a fuel cell unit;
a fuel storage unit connected to the fuel cell unit for supplying fuel to the fuel cell unit; and
a unit powered by the fuel cell unit;
wherein the powered unit is positioned adjacent to the fuel storage unit in order to transfer heat from the powered unit by exploiting an endothermic process occurring when emitting fuel from said fuel storage unit to said fuel cell unit.

20. A base station in a radio access network including a fuel cell used as a backup power source, wherein the fuel cell is included in an arrangement for improving the operating conditions of the base station, which arrangement includes:
a fuel cell unit;
a fuel storage unit connected to the fuel cell unit for supplying fuel to the fuel cell unit; and
a unit included by the base station and powered by the fuel cell unit;
wherein the powered unit is positioned adjacent to the fuel storage unit in order to transfer heat from the powered unit by exploiting an endothermic process occurring when emitting fuel from said fuel storage unit to said fuel cell unit.
